(19) United States
(12) Patent Application Publication
(10) Pub. No.: US 2026/0098838 A1
(43) Pub. Date: Apr. 9, 2026

(54) COMPOSITE REFERENCE STRUCTURES

(71) Applicant: The Boeing Company, Arlington, VA (US)

(72) Inventors: Luka Culjak, Fenton, MO (US); Elizabeth Ann Paton, Saint Louis, MO (US)

(21) Appl. No.: 19/345,983

(22) Filed: Sep. 30, 2025

Related U.S. Application Data
(60) Provisional application No. 63/705,259, filed on Oct. 9, 2024.

(51) Int. Cl. G01N 29/44; G01N 29/22

(52) U.S. Cl. CPC G01N 29/4409; G01N 29/22

(57) ABSTRACT

Disclosed examples include a first surface; a second surface opposing the first surface; a perimetric barrier along a perimeter of the second surface, the perimetric barrier protruding away from the second surface; an aperture formed through the first and second surfaces; and structural features formed on the second surface, the structural features extending between the aperture and the perimetric barrier.

### RELATED APPLICATION

This patent claims the benefit of U.S. Provisional Ser. No. 63/705,259 which was filed on Oct. 9, 2024. U.S. Provisional Ser. No. 63/705,259 is hereby incorporated herein by reference in its entirety. Priority to U.S. Provisional Ser. No. 63/705,259 is hereby claimed.

### FIELD OF THE DISCLOSURE

This disclosure relates generally to material inspection and, more particularly, to composite reference structures.

### BACKGROUND

Manufacturing parts can involve numerous stages to perform different processes on a manufactured part. Such stages can involve creating materials, cutting materials, and bonding materials. Any stage in a manufacturing process can introduce a defect in a manufactured part. To monitor for such defects, a quality inspection stage can be implemented to inspect manufactured parts.

### BRIEF DESCRIPTION OF THE DRAWINGS

FIG. 1 is a side view of an example measurement reference structure.

FIG. 2A is a perspective view of the measurement reference structure of FIG. 1.

FIG. 2B is a perspective view of another example measurement reference structure having structural strength features.

FIG. 3 is a side view of an example composite inspection reference structure including the measurement reference structure of FIG. 1 between two laminates.

FIG. 4 is a side view of an example partial composite inspection reference structure including the measurement reference structure of FIGS. 1, 2A, and 3 bonded to the bottom laminate of FIG. 3.

FIG. 5 is a perspective view of the example partial composite inspection reference structure of FIG. 4.

FIG. 6 is a top view of a partial multi-reference composite inspection reference structure including five measurement reference structures bonded to a bottom laminate.

FIG. 7 is a flowchart representative of example machine-readable instructions and/or example operations that may be executed, instantiated, and/or performed by example programmable circuitry to create the measurement reference structures of FIGS. 1, 2A, 2B, and 3-5.

FIG. 8 is a block diagram of an example processing platform including programmable circuitry structured to execute, instantiate, and/or perform the example machine-readable instructions and/or perform the example operations of FIG. 7 to create the measurement reference structures of FIGS. 1, 2A, 2B, and 3-5.

FIG. 9 is a block diagram of an example software/firmware/instructions distribution platform (e.g., one or more servers) to distribute software, instructions, and/or firmware (e.g., corresponding to the example machine-readable instructions of FIG. 7) to client devices associated with end users and/or consumers (e.g., for license, sale, and/or use), retailers (e.g., for sale, re-sale, license, and/or sub-license), and/or original equipment manufacturers (OEMs) (e.g., for inclusion in products to be distributed to, for example, retailers and/or to other end users such as direct buy customers).

In general, the same reference numbers will be used throughout the drawings and accompanying written description to refer to the same or like parts. The figures are not necessarily to scale. Instead, the thicknesses of the layers or regions may be enlarged in the drawings. Although the figures show layers and regions with clean lines and boundaries, some or all of these lines and/or boundaries may be idealized. In reality, the boundaries and/or lines may be unobservable, blended, and/or irregular.

### DETAILED DESCRIPTION

Non-destructive ultrasonic testing of materials can be used to determine whether a material has a missing-material defect (e.g., an air pocket, an air bubble, missing laminate material, missing adhesive, etc.). Such non-destructive testing can use a reference measurement structure that includes a missing-material defect for use in measuring acoustic signal characteristics of that defect. The acoustic signal characteristics can then be compared to measured acoustic signal characteristics of production materials or production parts to detect the existence of any missing-material defects in those production materials or parts.

Prior techniques of creating reference measurement structures for non-destructive ultrasonic testing of materials include cutting away a specified defect size from a film adhesive prior to lay-up of the film adhesive to create an un-bond condition (e.g., an air pocket of missing material) between layered laminates of a laminate structure. When the laminate structure is under cure, the film adhesive flows and unequally fills the cut out void in a test panel structure. In this scenario, when the laminate structure is ultrasonically inspected, a size of a final reference missing-material defect is smaller than expected (e.g., it has been partially filled by adhesive) or the final reference missing-material defect no longer exists (e.g., it has been fully filled by adhesive). Therefore, the expected un-bond condition does not exist.

Another prior solution includes placing other materials above and below a film adhesive bondline (e.g., a layer of film adhesive between two adjacent laminates) to induce an un-bond condition. Typical materials include polyimide film pillows, doubled over polyimide film tape with an air pocket, and adhesive-resistant coating on a brass strip. A drawback of this method is that the final size of a reference missing-material defect may be smaller than the desired size. Another drawback is the lack of a standardized method to produce reference missing-material defects based on the polyimide film material or adhesive-resistant coating. For example, polyimide film pillows are susceptible to losing the air pocket as plies are laid on top and under vacuum pressure. In addition, the adhesive-resistant coating may not be uniformly applied to the brass. Both polyimide film pillows and adhesive-resistant coatings can lead to partial or complete invasion of adhesive into the area of a desired missing-material defect reference.

Unlike prior techniques, examples disclosed herein may be used to create an un-bond condition in a particular area of a composite structure in a manner that is repeatedly reproducible with expected missing-material defect sizes across different composite inspection references for use in material/parts inspection processes. Example composite structures disclosed herein may be used to implement composite inspection references (e.g., composite inspection reference structures) to inspect manufactured parts for material defects using non-destructive acoustic (e.g., ultrasonic) signal inspection techniques. In examples disclosed herein, a composite inspection reference is used to represent a material defect in a manufactured part that is characterized by missing material. For example, when a sheet material is formed during a manufacturing process, a material void, cavity, or air pocket may form in the sheet material. Such an area of missing material is a defect that may decrease a strength of the material or long-term reliability of the material.

To detect missing-material defects in a manufactured part, an inspection process can use a composite inspection reference as a comparative defect condition that is compared to the manufactured part. The composite inspection reference simulates, resembles, or represents a missing-material defect so that comparatively analyzing a manufactured part based on that reference missing-material defect can reveal when the manufactured part includes that particular type of defect.

In the manufacture of parts using composite structures, a laminate is formed using one ply of sheet material or using a multi-layer structure having multiple plies bonded to one another by a film adhesive or foam adhesive. When the film or foam adhesive is cured, the multiple plies are bonded to one another by the intervening adhesive to form a laminate. A composite structure may be formed using one laminate or multiple laminates that are further bonded to one another using additional film or foam adhesive. Defects may occur from missing adhesive material (e.g., due to insufficient adhesive flow) or missing ply material in a laminate structure. In examples disclosed herein, a reference missing-material defect (e.g., an artificial missing-material defect) is created by creating a composite structure that intentionally includes an un-bond condition. In examples disclosed herein, an un-bond condition is an area devoid of an adhesive in a composite structure. That is, the un-bond condition refers to a portion of the composite structure at which adhesive is missing between adjacent laminates that are adhered to one another. Accordingly, this un-bond condition is an air gap between the two adjacently adhered laminates. In examples disclosed herein, the area of missing adhesive is defined by a bond perimeter or bondline in the bonded composite structure. The bond perimeter or bondline can be designed to make the un-bond condition have surface area of an expected size.

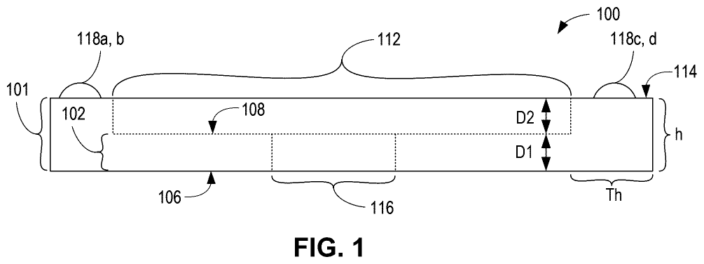

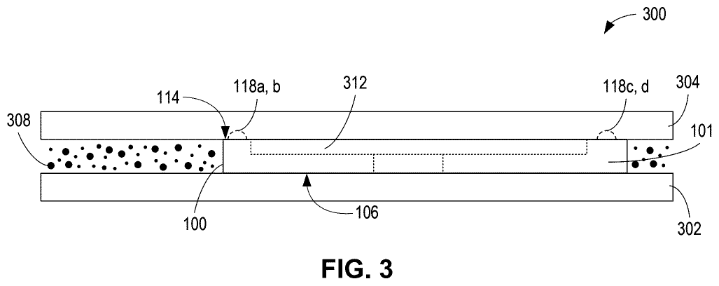

FIG. 1 is a side view of an example measurement reference structure 100 (e.g. a measurement reference standard). The measurement reference structure 100 is a laminate separator, spacer, or shim that creates a reference missing-material defect (e.g., an artificial missing-material defect) between adjacent laminates of a composite inspection reference structure (e.g., the composite inspection reference structure 300 of FIG. 3). As described in more detail below in connection with FIG. 3, the measurement reference structure 100 can be stacked between two laminates to prevent adhesive flow in an area defined by the measurement reference structure 100. Such adhesive flow prevention creates an un-bond condition between the two adjacently bonded laminates to represent a reference missing-material defect. Using measurement reference structures such as the measurement reference structure 100 enables creating consistently sized reference missing-material defects across the same or different composite inspection reference structures.

Measurement reference structures disclosed herein, such as the measurement reference structure 100, also enable creating repeatable reference missing-material defects of a known size and preventing adhesive characteristics from affecting the reference missing-material defect size. Accordingly, examples disclosed herein may be used to improve the accuracy of production parts inspection processes (e.g., for system and part qualifications).

The measurement reference structure 100 may be created using three-dimensional (3D) printing. To use 3D printing, the measurement reference structure 100 can be 3D printed using 3D-printable plastic having a melting-point that is higher than a flow temperature of an adhesive used to fabricate composite inspection reference structures (e.g., the composite inspection reference structure 300 of FIG. 3) that include the measurement reference structure 100. The melting-point of the 3D-printable plastic is also higher than the melting-points of laminates bonded with the measurement reference structure 100 to form composite inspection reference structures.

During a production parts inspection process, ultrasonic signal measurements are used to detect missing-material defects in a manufactured component. Ultrasound is used as a measurement signal because it is highly attenuated by an air medium. As such, an ultrasonic measurement signal undergoes significant or complete attenuation when it encounters a missing-material defect having an air pocket or air bubble in a wall of a manufactured component. The signal attenuation can be measured by an ultrasound inspection instrument and used to identify the presence of a missing-material defect.

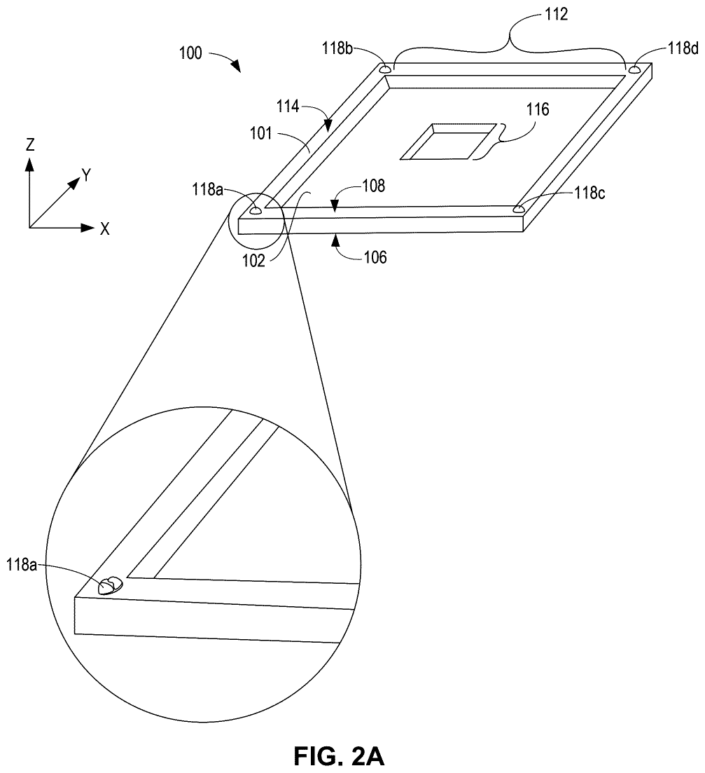

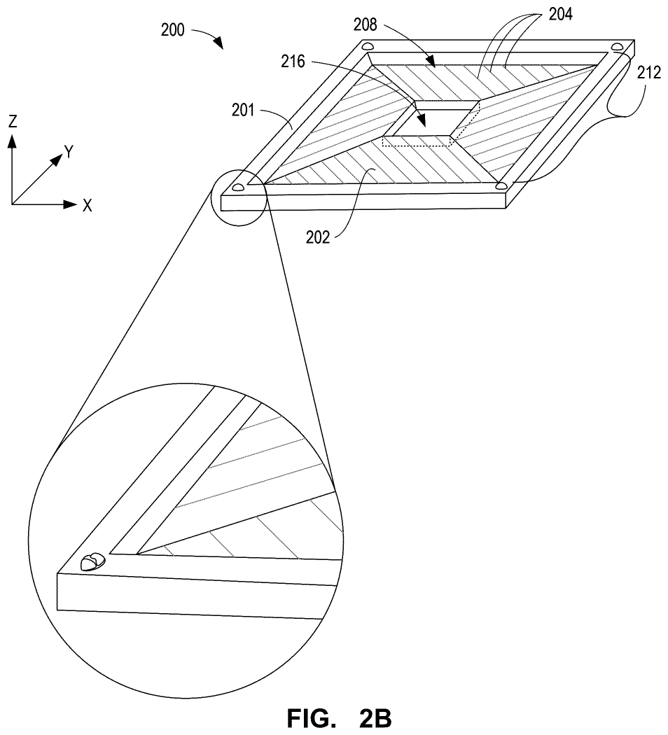

The measurement reference structure 100 is created to simulate or mimic a missing-material defect by creating an air pocket when assembled in a composite inspection reference structure (e.g., the composite inspection reference structure 300 of FIG. 3). However, plastic also highly attenuates ultrasound signals. As such, a 3D-printed plastic used to create the measurement reference structure 100 can increase, skew, or bias the ultrasound attenuation characteristics of a reference missing-material defect beyond the attenuation of an air gap (e.g., the air gap 312 of FIG. 3) created by the measurement reference structure 100. In examples disclosed herein, measurement reference structures (e.g., the measurement reference structures 100 of FIGS. 1 and 200 of FIG. 2B) are created using 3D-printed plastic while minimizing the amount of ultrasound signal attenuation bias added by the 3D-printed plastic. Accordingly, an ultrasonic attenuation characteristic of a reference missing-material defect created using a measurement reference structure in accordance with examples disclosed herein is sufficiently similar to an actual missing-material defect having an air gap in a production part. Use of the measurement reference structure 100 as a reference missing-material defect to detect actual missing-material defects in production parts improves inspection accuracies over prior techniques. For example, actual missing-material defects can be detected based on acoustic measures of those actual missing-material defects sufficiently matching acoustic measures of corresponding reference missing-material defects.

The measurement reference structure 100 includes an example perimetric barrier 101 (e.g., a perimetric barrier structure, a perimetric lip, a retaining wall, etc.) and an example support plate 102 (e.g., a base plate) having an example first surface 106 and an example second surface 108. The second surface 108 opposes the first surface 106 across a depth (D1) of the support plate 102. The support plate 102 is in the area delimited by the perimetric barrier 101 such that the perimetric barrier 101 is located along a perimeter of the first surface 106 and the second surface 108 to form an example well 112. The support plate 102 is a low infill lateral support structure to reinforce the perimetric barrier 101. The perimetric barrier 101 protrudes or extends away from the second surface 108 at a depth (D2) above the second surface 108 to create the well 112. The well 112 represents a missing-material defect when the measurement reference structure 100 is stacked and bonded between bottom and top laminates as described below in connection with FIG. 3.

A height (h) of the perimetric barrier 101 (e.g., a height of the measurement reference structure 100) is equal to a sum of the depth (D1) of the support plate 102 and the depth (D2) of the well 112. In some examples, the depth (D1) of the support plate 102 is equal to the depth (D2) of the well 112. In such examples, each of the depth (D1) of the support plate 102 and the depth (D2) of the well 112 is half the height (h) of the perimetric barrier 101 (e.g., D1=D2=½ h). In some examples, the height (h) of the perimetric barrier 101 can be selected to match a film or foam adhesive bondline thickness.

The perimetric barrier 101 has an example laminate-engagement surface 114. The laminate-engagement surface 114 engages a stacked laminate to create a seal between the laminate-engagement surface 114 and the stacked laminate. By forming this seal, the perimetric barrier 101 prevents adhesive from flowing into the well 112. A wall thickness (Th) of the perimetric barrier 101 can be selected based on the type of adhesive with which the measurement reference structure 100 is to be used. For example, different adhesives have different flow strengths that relate to how much fluid pressure or force the adhesives can exert against objects in their flow paths.

By preventing adhesive from entering the well 112, adhesive material does not contribute to increased attenuation of acoustic (e.g., ultrasound) transmissivity through the support plate 102 during production parts inspection processes. The material and thickness of the support plate 102 may be selected so that attenuation of acoustic transmission through the support plate 102 is minimal. The measurement reference structure 100 also includes an example aperture 116 (e.g., a void area) formed in the support plate 102 through the first surface 106 and the second surface 108. The aperture 116 is provided to further minimize attenuation of acoustic transmission through the measurement reference structure 100 during an inspection process.

Examples disclosed herein may be used in connection with transmissive acoustic (e.g., ultrasonic) measures (e.g., for thick composite materials greater than 0.011 mils) in which an acoustic transmitter and an acoustic receiver are placed on opposing sides of a material to measure how much acoustic signal transmits through the material. In some examples, a measure of an acoustic signal through the measurement reference structure 100 is an average of signal transmission through the support plate 102 and the aperture 116. Examples disclosed herein may additionally or alternatively be used in connection with reflective acoustic (e.g., ultrasonic) measures (e.g., for thin composite materials less than 0.011 mils) in which an acoustic transceiver is placed on one side of a material to transmit an acoustic signal into the material and measure how much acoustic signal is reflected back to the transceiver from the material.

The measurement reference structure 100 also includes example laminate-lock protrusions 118a-d on the laminate-engaging surface 114 of the perimetric barrier 101. The laminate-lock protrusions 118a-d extend from the perimetric barrier 101 away from the second surface 108. The laminate-lock protrusions 118a-d are provided to engage a stacked laminate in a manner that the laminate-lock protrusions 118a-d extend into the stacked laminate to lock the laminate in place. This prevents the stacked laminate from slipping or sliding relative to the measurement reference structure 100 after it is placed on the measurement reference structure 100. In some examples, one or more or all of the laminate-lock protrusions 118a-d are omitted.

FIG. 2A is a perspective view of the measurement reference structure 100 of FIG. 1. The measurement reference structure 100 is depicted in FIG. 2A relative to a three-dimensional (x, y, z) coordinate system in which a width of the measurement reference structure 100 extends along an x-axis, a length of the measurement reference structure 100 extends along a y-axis, and a z-axis of the three-dimensional coordinate system runs normal to a plane on the x and y axes. As shown in FIG. 2A, an area of the well 112 along the x and y axes is defined by a perimeter of the perimetric barrier 101. In the example of FIG. 2A, the measurement reference structure 100 and the perimetric barrier 101 are shown as a square. However, the measurement reference structure 100 and/or the perimetric barrier 101 may be implemented using any other suitable shape such as any polygonal shape (e.g., a rectangle, a trapezoid, a triangle, etc.) or non-polygonal shape (e.g., a circle, an oval, a semicircle, a crescent, etc.).

The aperture 116 is shown at a central location in the support plate 102 relative to the perimetric barrier 101. In other examples, the aperture 116 may be formed in the support plate 102 at any other suitable location relative to the perimetric barrier 101. In addition, although the aperture 116 is shown as a square, the aperture 116 may be implemented using any other suitable shape such as any polygonal shape (e.g., a rectangle, a trapezoid, a triangle, etc.) or non-polygonal shape (e.g., a circle, an oval, a semicircle, a crescent, etc.).

As shown in example FIG. 2A, the second surface 108 of the support plate 102 extends between the perimetric barrier 101 and the aperture 116. The surface area of the second surface 108 may be selected so that the support plate 102 provides sufficient lateral support strength to reinforce the perimetric barrier 101 against lateral forces imparted by adhesive flowing against the outer sides of the perimetric barrier 101. In addition, the size (e.g., an area) of the aperture 116 may be selected to be as large as possible to minimize the amount of signal attenuated by the support plate 102 when acoustic inspection signals are transmitted through the measurement reference structure 100 in a direction substantially normal (e.g., the z-axis) to the support plate 102 during inspection processes. Due to the aperture 116 being formed through the support plate 102, the surface area size of the second surface 108 is inversely proportional to the area size of the aperture 116. For example, increasing the size of the aperture 116 decreases the surface area of the second surface 108. Therefore, the measurement reference structure 100 has a trade-off characteristic between having sufficient reinforcement strength provided by the support plate 102 to the perimetric barrier 101 and having a sufficiently large air interface area in the aperture 116 to minimize the amount of acoustic signal attenuated by the support plate 102. Accordingly, the maximum size (e.g., area) of the aperture 116 is limited by the minimum amount of surface area of the second surface 108 that is sufficient to strengthen the perimetric barrier 101 against lateral forces imparted by adhesive flow.

In the example of FIG. 2A, the second surface 108 is relatively smooth. FIG. 2B is a perspective view of another example measurement reference structure 200 (e.g. a measurement reference standard) that includes an example perimetric barrier 201 (e.g., a perimetric barrier structure, a perimetric lip, a retaining wall, etc.) substantially similar or identical to the perimetric barrier 101 of FIGS. 1 and 2A. The measurement reference structure 200 also includes an example support plate 202 (e.g., a base plate) having a top surface 208. The perimetric barrier 201 protrudes or extends from the support plate 202 away from the top surface 208 and is substantially normal to the top surface 208, creating an example well 212 defined by the perimeter of the perimetric barrier 201. The measurement reference structure 200 also includes an example aperture 216 in the support plate 202. The aperture 216 is substantially similar or identical to the aperture 116 of FIGS. 1 and 2A.

In the example of FIG. 2B, example structural strength features 204 are formed on the top surface 208. The structural strength features 204 extend between the aperture 216 and the perimetric barrier 201. The structural strength features 204 reinforce the support plate 202 to increase the lateral support strength provided by the support plate 202 to the perimetric barrier 201 against lateral forces imparted by adhesive flowing against the outer sides of the perimetric barrier 201. For example, the structural strength features 204 may be implemented as ridges. Some of the ridges may be at different angles to one another, creating a cross-hatching structure. In this cross-hatching structure, the ridges abut one another to form different-sized triangular regions. Such triangular regions form a lateral truss support system for the perimetric barrier 201.

In some examples, using the structural strength features 204 enables decreasing the size of the surface area of the second surface 208 while still providing sufficient strength to the perimetric barrier 201 against lateral forces imparted by adhesive flow. Accordingly, decreasing the surface area size of the second surface 208 enables increasing the area size of the aperture 216 to increase the amount of light transmissivity through the measurement reference structure 200. Although the structural strength features 204 are shown in FIG. 2B as straight line ridges, the structural strength features 204 may be implemented using any other suitable geometry.

In examples disclosed herein, 3D printing can be used to create a height (h) of the perimetric barrier 101, 201 to be equivalent to a thickness of a film adhesive or a foam adhesive. The 3D printing can also maintain minimal groove depths for the structural strength features 204 inside the well 212. In addition, 3D printing can be used to create the measurement reference structure 100, 200 to include missing-material defects that are similarly sized (e.g., similar area size) as actual defects in production parts. The use of 3D printing also provides for a defect area that does not add significant artificial attenuation when the measurement reference structure 100, 200 is being ultrasonically inspected. Accordingly, the 3D-printed measurement reference structures 100, 200 can be used to increase accuracies of testing whether production parts include missing-material defects.

FIG. 3 is a side view of an example composite inspection reference structure 300 (e.g., a composite reference standard, a composite material standard, a bonded assembly, etc.) including the measurement reference structure 100 of FIG. 1 between an example bottom laminate 302 and an example top laminate 304. The composite inspection reference structure 300 is a bonded assembly in which the bottom laminate 302 engages the first surface 106 of the measurement reference structure 100. In addition, the top laminate 304 engages the laminate-engagement surface 114 of the perimetric barrier 101 to create a seal along a perimeter defined by the perimetric barrier 101. In the example of FIG. 3, the laminate-lock protrusions 118a-d deform the top laminate 304 and extend into the top laminate 304 to lock it in place and keep it from shifting relative to the measurement reference structure 100.

An example adhesive 308 is disposed between the bottom laminate 302 and the top laminate 304. The adhesive 308 abuts the perimetric barrier 101 so that the perimetric barrier 101 and the seal between the top laminate 304 and the perimetric barrier 101 separate the adhesive 308 from an example air gap 312 (e.g., the well 112 of FIGS. 1 and 2A) within the perimeter defined by the perimetric barrier 101. In the example of FIG. 3, the air gap 312 represents a missing-material defect. In examples disclosed herein, a thickness of a support plate (e.g., the support plates 102, 202 of FIGS. 1, 2A, and 2B) is selected as thin as possible to maximize the depth of the air gap 312 (e.g., the depth (D2) of the well 112 of FIG. 1) so that the support plate introduces as little acoustic signal attenuation as possible to the signal attenuation characteristic of the air gap 312.

The adhesive 308 creates a lateral fluid pressure against the perimetric barrier 101. The lateral strength provided by the support plate 102 to the perimetric barrier 101 exceeds the lateral fluid pressure created by the adhesive 308. This prevents the adhesive 308 from permeating the perimetric barrier 101 and, thus, from entering the air gap 312. Although the composite inspection reference structure 300 is shown with the measurement reference structure 100, the composite inspection reference structure 300 may alternatively be implemented with the measurement reference structure 200 of FIG. 2B. In such examples, the lateral strength of the structural strength features 204 on the support plate 202 exceeds the lateral fluid pressure created by the adhesive 308 against the perimetric barrier 201. This prevents the adhesive 308 from permeating the perimetric barrier 201 and, thus, from entering the air gap 312.

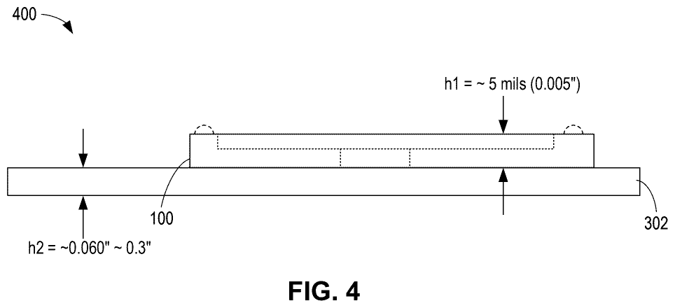

FIG. 4 is a side view of an example partial composite inspection reference structure 400 (e.g., a partial composite reference standard, a partial composite material standard, a partial bonded assembly, etc.) including the measurement reference structure 100 of FIGS. 1, 2A, and 3 bonded to the bottom laminate 302 of FIG. 3. In the example of FIG. 4, an example height (h1) of the measurement reference structure 100 (e.g., the height of the perimetric barrier 101, 201 of FIGS. 1, 2A, 2B, and 3) is shown as approximately 5 mils (e.g., 0.005 inches). Also in the example of FIG. 4, an example height (h2) of the bottom laminate 302 is approximately 60 to 300 mils (e.g., 0.060 inches to 0.300 inches). However, any other suitable dimensions may be used to implement measurement reference structures and composite inspection reference structures in accordance with teachings of this disclosure.

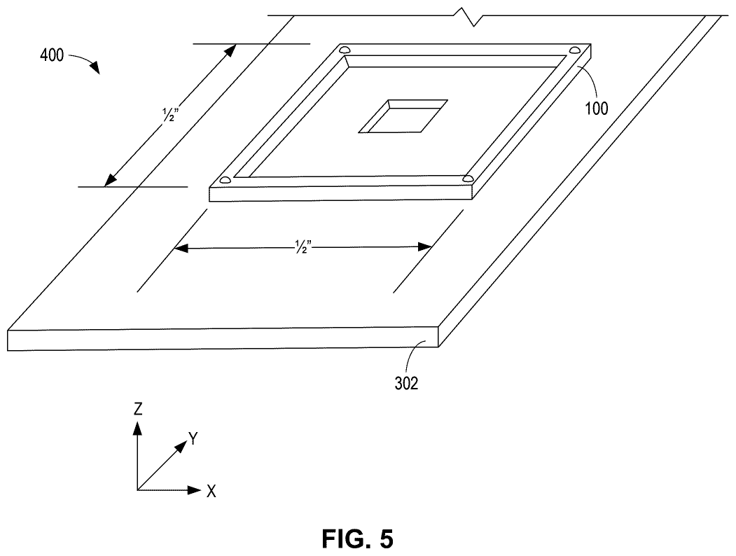

FIG. 5 is a perspective view of the example partial composite inspection reference structure 400 of FIG. 4. In the example of FIG. 5, an example length of the measurement reference structure 100 is approximately half of an inch and an example width of the measurement reference structure 100 is approximately half of an inch. The measurement reference structure 100 may be differently sized to create approximate lengths and widths between quarter of an inch to an inch (e.g., length=˜0.25 inch to ˜1 inch and width=˜0.25 inch to ˜1 inch). However, any other suitable dimensions may be used to implement measurement reference structures and composite inspection reference structures in accordance with teachings of this disclosure.

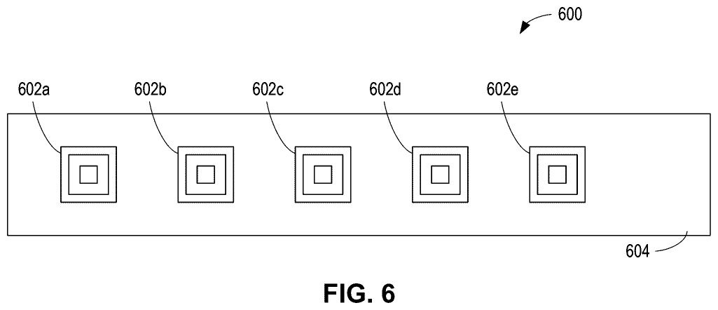

FIG. 6 is a top view of a partial multi-reference composite inspection reference structure 600 including five measurement reference structures 602a-e bonded to an example bottom laminate 604. The measurement reference structures 602a-e are shown similarly sized. However, in other examples, the measurement reference structures 602a-e may be sized differently from one another to represent different-sized missing material defects. In addition, although the five measurement reference structures 602a-e are shown in the partial multi-reference composite inspection reference structure 600, in other examples fewer or more measurement reference structures may be implemented in a multi-reference composite inspection reference structure.

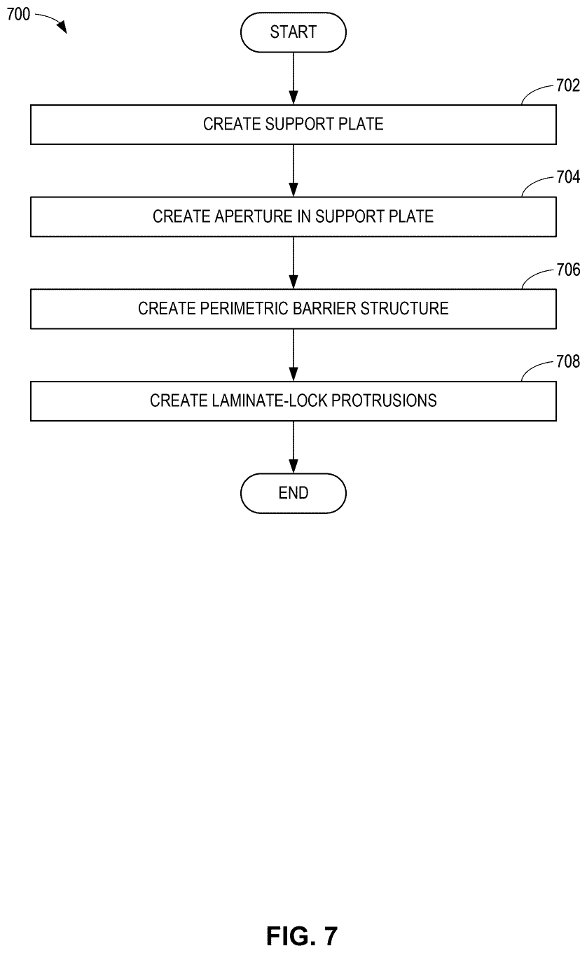

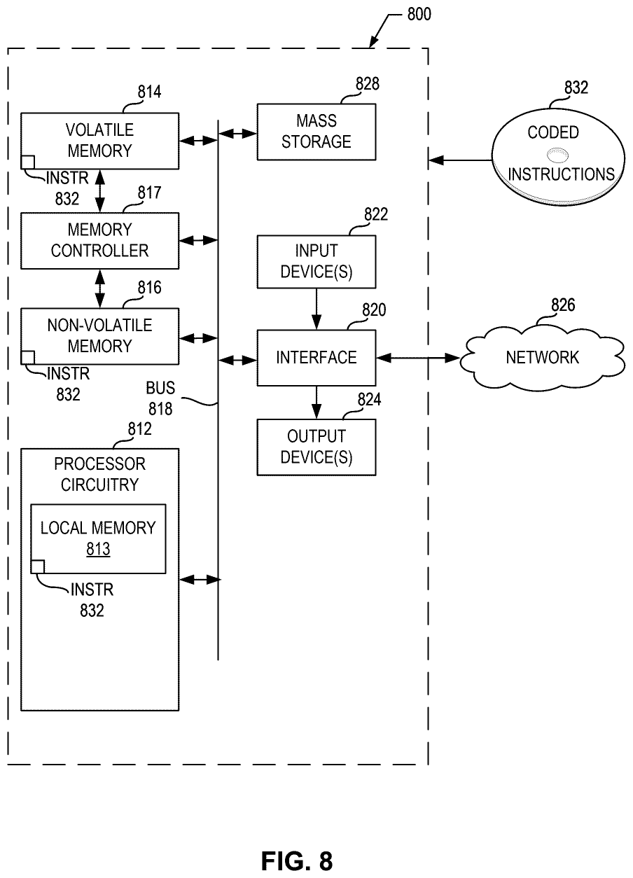

A flowchart representative of example machine-readable instructions, which may be executed by programmable circuitry to create the measurement reference structure 100, 200 of FIGS. 1, 2A, 2B, and 3-5 and/or representative of example operations which may be performed by programmable circuitry to create the measurement reference structure 100, 200 is shown in FIG. 7. The machine-readable instructions may be one or more executable programs or portion(s) of one or more executable programs for execution by programmable circuitry such as the programmable circuitry 812 shown in the example processor platform 800 discussed below in connection with FIG. 8 and/or may be one or more function(s) or portion(s) of functions to be performed by example programmable circuitry (e.g., an Field Programmable Gate Array (FPGA)). In some examples, the machine-readable instructions cause an operation, a task, etc., to be carried out and/or performed in an automated manner in the real world. As used herein, “automated” means without human involvement.

The program may be embodied in instructions (e.g., software and/or firmware) stored on one or more non-transitory computer-readable and/or machine-readable storage medium such as cache memory, a magnetic-storage device or disk (e.g., a floppy disk, a Hard Disk Drive (HDD), etc.), an optical-storage device or disk (e.g., a Blu-ray disk, a Compact Disk (CD), a Digital Versatile Disk (DVD), etc.), a Redundant Array of Independent Disks (RAID), a register, ROM, a solid-state drive (SSD), SSD memory, non-volatile memory (e.g., electrically erasable programmable read-only memory (EEPROM), flash memory, etc.), volatile memory (e.g., Random Access Memory (RAM) of any type, etc.), and/or any other storage device or storage disk. The instructions of the non-transitory computer-readable and/or machine-readable medium may program and/or be executed by programmable circuitry located in one or more hardware devices, but the entire program and/or parts thereof could alternatively be executed and/or instantiated by one or more hardware devices other than the programmable circuitry and/or embodied in dedicated hardware. The machine-readable instructions may be distributed across multiple hardware devices and/or executed by two or more hardware devices (e.g., a server and a client hardware device). For example, the client hardware device may be implemented by an endpoint client hardware device (e.g., a hardware device associated with a human and/or machine user) or an intermediate client hardware device gateway (e.g., a radio access network (RAN)) that may facilitate communication between a server and an endpoint client hardware device. Similarly, the non-transitory computer-readable storage medium may include one or more mediums. Further, although the example program is described with reference to the flowchart illustrated in FIG. 7, many other methods of creating the measurement reference structures 100, 200 may alternatively be used. For example, the order of execution of the blocks of the flowchart may be changed, and/or some of the blocks described may be changed, eliminated, or combined. Additionally or alternatively, any or all of the blocks of the flowchart may be implemented by one or more hardware circuits (e.g., processor circuitry, discrete and/or integrated analog and/or digital circuitry, an FPGA, an ASIC, a comparator, an operational-amplifier (op-amp), a logic circuit, etc.) structured to perform the corresponding operation without executing software or firmware. The programmable circuitry may be distributed in different network locations and/or local to one or more hardware devices (e.g., a single-core processor (e.g., a single core Central Processor Unit (CPU)), a multi-core processor (e.g., a multi-core CPU, an XPU, etc.)). For example, the programmable circuitry may be a CPU and/or an FPGA located in the same package (e.g., the same integrated circuit (IC) package or in two or more separate housings), one or more processors in a single machine, multiple processors distributed across multiple servers of a server rack, multiple processors distributed across one or more server racks, etc., and/or any combination(s) thereof.

The machine-readable instructions described herein may be stored in one or more of a compressed format, an encrypted format, a fragmented format, a compiled format, an executable format, a packaged format, etc. Machine-readable instructions as described herein may be stored as data (e.g., computer-readable data, machine-readable data, one or more bits (e.g., one or more computer-readable bits, one or more machine-readable bits, etc.), a bitstream (e.g., a computer-readable bitstream, a machine-readable bitstream, etc.), etc.) or a data structure (e.g., as portion(s) of instructions, code, representations of code, etc.) that may be utilized to create, manufacture, and/or produce machine-executable instructions. For example, the machine-readable instructions may be fragmented and stored on one or more storage devices, disks and/or computing devices (e.g., servers) located at the same or different locations of a network or collection of networks (e.g., in the cloud, in edge devices, etc.). The machine-readable instructions may require one or more of installation, modification, adaptation, updating, combining, supplementing, configuring, decryption, decompression, unpacking, distribution, reassignment, compilation, etc., in order to make them directly readable, interpretable, and/or executable by a computing device and/or other machine. For example, the machine-readable instructions may be stored in multiple parts, which are individually compressed, encrypted, and/or stored on separate computing devices, wherein the parts when decrypted, decompressed, and/or combined form a set of computer-executable and/or machine-executable instructions that implement one or more functions and/or operations that may together form a program such as that described herein.

In another example, the machine-readable instructions may be stored in a state in which they may be read by programmable circuitry, but require addition of a library (e.g., a dynamic link library (DLL)), a software development kit (SDK), an application programming interface (API), etc., in order to execute the machine-readable instructions on a particular computing device or other device. In another example, the machine-readable instructions may need to be configured (e.g., settings stored, data input, network addresses recorded, etc.) before the machine-readable instructions and/or the corresponding program(s) can be executed in whole or in part. Thus, machine-readable, computer-readable and/or machine-readable media, as used herein, may include instructions and/or program(s) regardless of the particular format or state of the machine-readable instructions and/or program(s).

The machine-readable instructions described herein can be represented by any past, present, or future instruction language, scripting language, programming language, etc. For example, the machine-readable instructions may be represented using any of the following languages: C, C++, Java, C #, Perl, Python, JavaScript, HyperText Markup Language (HTML), Structured Query Language (SQL), Swift, etc.

As mentioned above, the example operations 700 of FIG. 7 may be implemented using executable instructions (e.g., computer-readable and/or machine-readable instructions) stored on one or more non-transitory computer-readable and/or machine-readable media. As used herein, the terms non-transitory computer-readable medium, non-transitory computer-readable storage medium, non-transitory machine-readable medium, and/or non-transitory machine-readable storage medium are expressly defined to include any type of computer-readable storage device and/or storage disk and to exclude propagating signals and to exclude transmission media. Examples of such non-transitory computer-readable medium, non-transitory computer-readable storage medium, non-transitory machine-readable medium, and/or non-transitory machine-readable storage medium include optical storage devices, magnetic storage devices, an HDD, a flash memory, a read-only memory (ROM), a CD, a DVD, a cache, a RAM of any type, a register, and/or any other storage device or storage disk in which information is stored for any duration (e.g., for extended time periods, permanently, for brief instances, for temporarily buffering, and/or for caching of the information). As used herein, the terms “non-transitory computer-readable storage device” and “non-transitory machine-readable storage device” are defined to include any physical (mechanical, magnetic and/or electrical) hardware to retain information for a time period, but to exclude propagating signals and to exclude transmission media. Examples of non-transitory computer-readable storage devices /d/ or non-transitory machine-readable storage devices include random access memory of any type, read only memory of any type, solid state memory, flash memory, optical discs, magnetic disks, disk drives, and/or redundant array of independent disks (RAID) systems. As used herein, the term “device” refers to physical structure such as mechanical and/or electrical equipment, hardware, and/or circuitry that may or may not be configured by computer-readable instructions, machine-readable instructions, etc., and/or manufactured to execute computer-readable instructions, machine-readable instructions, etc.

FIG. 7 is a flowchart representative of example machine-readable instructions and/or example operations 700 that may be executed, instantiated, and/or performed by example programmable circuitry (e.g., the programmable circuitry 810 of FIG. 8) to create the measurement reference structures 100, 200 of FIGS. 1, 2A, 2B, and 3-5. The instructions and/or operations 700 may be used to control a 3D printer to 3D print the measurement reference structures 100, 200. The instructions and/or operations 700 begin at block 702 at which the support plate 102, 202 (FIGS. 1, 2A, and 2B) is created. For example, a 3D printer may 3D print the support plate 102, 202. In some examples, the 3D printer prints the structural strength features 204 in the top surface of the support plate 202 as shown in FIG. 2B. In other examples, the 3D printer prints the support plate 102 with the relatively smooth second surface 108 as shown in FIG. 2A.

At block 704, the aperture 116, 216 (FIGS. 1, 2A, and 2B) is created in the support plate 102, 202. For example, a 3D printer may 3D print the aperture 116, 216. At block 706, the perimetric barrier 101, 201 (FIGS. 1, 2A, and 2B) is created. For example, a 3D printer may 3D print the perimetric barrier 101, 201 along a perimeter of the support plate 102, 202 such that the perimetric barrier 101, 201 protrudes or extends away from the support plate 102, 202 in a direction substantially normal to the support plate 102, 202.

At block 708, the laminate-lock protrusions 118a-d (FIGS. 1, 2A, and 3) are created. For example, a 3D printer may 3D print the laminate-lock protrusions 118a-d on the perimetric barrier 101, 201. The instructions and/or operations 700 end.

FIG. 8 is a block diagram of an example programmable circuitry platform 800 structured to execute and/or instantiate the example machine-readable instructions and/or the example operations of FIG. 7 to create the measurement reference structures 100, 200 of FIGS. 1, 2A, 2B, and 3-5. The programmable circuitry platform 800 can be, for example, a server, a personal computer, a workstation, a self-learning machine (e.g., a neural network), a mobile device (e.g., a cell phone, a smart phone, a tablet such as an iPad™), an Internet appliance, or any other type of computing and/or electronic device.

The programmable circuitry platform 800 of the illustrated example includes programmable circuitry 812. The programmable circuitry 812 of the illustrated example is hardware. For example, the programmable circuitry 812 can be implemented by one or more integrated circuits, logic circuits, FPGAs, microprocessors, CPUs, Graphics Processor Units (GPUs), Digital Signal Processors (DSPs), and/or microcontrollers from any desired family or manufacturer. The programmable circuitry 812 may be implemented by one or more semiconductor based (e.g., silicon based) devices.

The programmable circuitry 812 of the illustrated example includes a local memory 813 (e.g., a cache, registers, etc.). The programmable circuitry 812 of the illustrated example is in communication with main memory 814, 816, which includes a volatile memory 814 and a non-volatile memory 816, by a bus 818. The volatile memory 814 may be implemented by Synchronous Dynamic Random Access Memory (SDRAM), Dynamic Random Access Memory (DRAM), RAMBUS® Dynamic Random Access Memory (RDRAM®), and/or any other type of RAM device. The non-volatile memory 816 may be implemented by flash memory and/or any other desired type of memory device. Access to the main memory 814, 816 of the illustrated example is controlled by a memory controller 817. In some examples, the memory controller 817 may be implemented by one or more integrated circuits, logic circuits, microcontrollers from any desired family or manufacturer, or any other type of circuitry to manage the flow of data going to and from the main memory 814, 816.

The programmable circuitry platform 800 of the illustrated example also includes interface circuitry 820. The interface circuitry 820 may be implemented by hardware in accordance with any type of interface standard, such as an Ethernet interface, a universal serial bus (USB) interface, a Bluetooth® interface, a near field communication (NFC) interface, a Peripheral Component Interconnect (PCI) interface, and/or a Peripheral Component Interconnect Express (PCIe) interface.

In the illustrated example, one or more input devices 822 are connected to the interface circuitry 820. The input device(s) 822 permit(s) a user (e.g., a human user, a machine user, etc.) to enter data and/or commands into the programmable circuitry 812. The input device(s) 822 can be implemented by, for example, an audio sensor, a microphone, a camera (still or video), a keyboard, a button, a mouse, a touchscreen, a trackpad, a trackball, an isopoint device, and/or a voice recognition system.

One or more output devices 824 are also connected to the interface circuitry 820 of the illustrated example. The output device(s) 824 can be implemented, for example, by display devices (e.g., a light emitting diode (LED), an organic light emitting diode (OLED), a liquid crystal display (LCD), a cathode ray tube (CRT) display, an in-place switching (IPS) display, a touchscreen, etc.), a tactile output device, 3D printer, a printer, and/or speaker. The interface circuitry 820 of the illustrated example, thus, typically includes a graphics driver card, a graphics driver chip, and/or graphics processor circuitry such as a GPU.

The interface circuitry 820 of the illustrated example also includes a communication device such as a transmitter, a receiver, a transceiver, a modem, a residential gateway, a wireless access point, and/or a network interface to facilitate exchange of data with external machines (e.g., computing devices of any kind) by a network 826. The communication can be by, for example, an Ethernet connection, a digital subscriber line (DSL) connection, a telephone line connection, a coaxial cable system, a satellite system, a beyond-line-of-sight wireless system, a line-of-sight wireless system, a cellular telephone system, an optical connection, etc.

The programmable circuitry platform 800 of the illustrated example also includes one or more mass storage discs or devices 828 to store firmware, software, and/or data. Examples of such mass storage discs or devices 828 include magnetic storage devices (e.g., floppy disk, drives, HDDs, etc.), optical storage devices (e.g., Blu-ray disks, CDs, DVDs, etc.), RAID systems, and/or solid-state storage discs or devices such as flash memory devices and/or SSDs.

The machine-readable instructions 832, which may be implemented by the machine-readable instructions of FIG. 7, may be stored in the mass storage device 828, in the volatile memory 814, in the non-volatile memory 816, and/or on at least one non-transitory computer-readable storage medium such as a CD or DVD which may be removable.

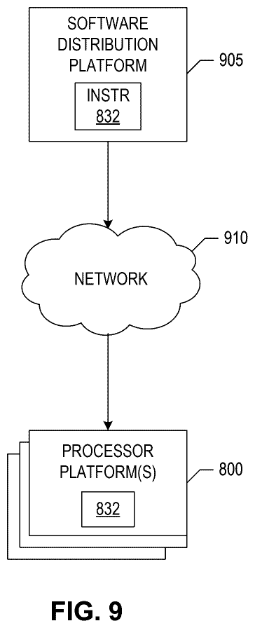

A block diagram illustrating an example software distribution platform 905 to distribute software such as the example machine-readable instructions 832 of FIG. 8 to other hardware devices (e.g., hardware devices owned and/or operated by third parties from the owner and/or operator of the software distribution platform) is illustrated in FIG. 9. The example software distribution platform 905 may be implemented by any computer server, data facility, cloud service, etc., capable of storing and transmitting software to other computing devices. The third parties may be customers of the entity owning and/or operating the software distribution platform 905. For example, the entity that owns and/or operates the software distribution platform 905 may be a developer, a seller, and/or a licensor of software such as the example machine-readable instructions 832 of FIG. 8. The third parties may be consumers, users, retailers, OEMs, etc., who purchase and/or license the software for use and/or re-sale and/or sub-licensing. In the illustrated example, the software distribution platform 905 includes one or more servers and one or more storage devices. The storage devices store the machine-readable instructions 832, which may correspond to the example machine-readable instructions of FIG. 7, as described above. The one or more servers of the example software distribution platform 905 are in communication with an example network 910, which may correspond to any one or more of the Internet and/or any of the example networks described above. In some examples, the one or more servers are responsive to requests to transmit the software to a requesting party as part of a commercial transaction. Payment for the delivery, sale, and/or license of the software may be handled by the one or more servers of the software distribution platform and/or by a third-party payment entity. The servers enable purchasers and/or licensors to download the machine-readable instructions 832 from the software distribution platform 905. For example, the software, which may correspond to the example machine-readable instructions of FIG. 7, may be downloaded to the example programmable circuitry platform 800, which is to execute the machine-readable instructions 832 to create the measurement reference structures 100, 200 of FIGS. 1, 2A, 2B, and 3-5. In some examples, one or more servers of the software distribution platform 905 periodically offer, transmit, and/or force updates to the software (e.g., the example machine-readable instructions 832 of FIG. 8) to ensure improvements, patches, updates, etc., are distributed and applied to the software at the end user devices. Although referred to as software above, the distributed “software” could alternatively be firmware.

“Including” and “comprising” (and all forms and tenses thereof) are used herein to be open ended terms. Thus, whenever a claim employs any form of “include” or “comprise” (e.g., comprises, includes, comprising, including, having, etc.) as a preamble or within a claim recitation of any kind, it is to be understood that additional elements, terms, etc., may be present without falling outside the scope of the corresponding claim or recitation. As used herein, when the phrase “at least” is used as the transition term in, for example, a preamble of a claim, it is open-ended in the same manner as the term “comprising” and “including” are open ended. The term “and/or” when used, for example, in a form such as A, B, and/or C refers to any combination or subset of A, B, C such as (1) A alone, (2) B alone, (3) C alone, (4) A with B, (5) A with C, (6) B with C, or (7) A with B and with C. As used herein in the context of describing structures, components, items, objects and/or things, the phrase “at least one of A and B” is intended to refer to implementations including any of (1) at least one A, (2) at least one B, or (3) at least one A and at least one B. Similarly, as used herein in the context of describing structures, components, items, objects and/or things, the phrase “at least one of A or B” is intended to refer to implementations including any of (1) at least one A, (2) at least one B, or (3) at least one A and at least one B. As used herein in the context of describing the performance or execution of processes, instructions, actions, activities, etc., the phrase “at least one of A and B” is intended to refer to implementations including any of (1) at least one A, (2) at least one B, or (3) at least one A and at least one B. Similarly, as used herein in the context of describing the performance or execution of processes, instructions, actions, activities, etc., the phrase “at least one of A or B” is intended to refer to implementations including any of (1) at least one A, (2) at least one B, or (3) at least one A and at least one B.

As used herein, singular references (e.g., “a”, “an”, “first”, “second”, etc.) do not exclude a plurality. The term “a” or “an” object, as used herein, refers to one or more of that object. The terms “a” (or “an”), “one or more”, and “at least one” are used interchangeably herein. Furthermore, although individually listed, a plurality of means, elements, or actions may be implemented by, e.g., the same entity or object. Additionally, although individual features may be included in different examples or claims, these may possibly be combined, and the inclusion in different examples or claims does not imply that a combination of features is not feasible and/or advantageous.

As used herein, unless otherwise stated, the term “above” or “top” describes the relationship of two parts relative to Earth. A first part is above or on top of a second part, if the second part has at least one part between Earth and the first part. Likewise, as used herein, a first part is “below” a second part or is a “bottom” feature or component relative to the second part when the first part is closer to the Earth than the second part. As noted above, a first part can be above or below a second part with one or more of: other parts therebetween, without other parts therebetween, with the first and second parts touching, or without the first and second parts being in direct contact with one another.

As used in this patent, stating that any part (e.g., a layer, film, area, region, or plate) is in any way on (e.g., positioned on, located on, disposed on, or formed on, etc.) another part, indicates that the referenced part is either in contact with the other part, or that the referenced part is above the other part with one or more intermediate part(s) located therebetween.

As used herein, connection references (e.g., attached, coupled, connected, and joined) may include intermediate members between the elements referenced by the connection reference and/or relative movement between those elements unless otherwise indicated. As such, connection references do not necessarily infer that two elements are directly connected and/or in fixed relation to each other. As used herein, stating that any part is in “contact” with another part is defined to mean that there is no intermediate part between the two parts.

Unless specifically stated otherwise, descriptors such as “first,” “second,” “third,” etc., are used herein without imputing or otherwise indicating any meaning of priority, physical order, arrangement in a list, and/or ordering in any way, but are merely used as labels and/or arbitrary names to distinguish elements for ease of understanding the disclosed examples. In some examples, the descriptor “first” may be used to refer to an element in the detailed description, while the same element may be referred to in a claim with a different descriptor such as “second” or “third.” In such instances, it should be understood that such descriptors are used merely for identifying those elements distinctly within the context of the discussion (e.g., within a claim) in which the elements might, for example, otherwise share a same name.

As used herein, “approximately” and “about” modify their subjects/values to recognize the potential presence of variations that occur in real world applications. For example, “approximately” and “about” may modify dimensions that may not be exact due to manufacturing tolerances and/or other real world imperfections as will be understood by persons of ordinary skill in the art. For example, “approximately” and “about” may indicate such dimensions may be within a tolerance range of +/−10% unless otherwise specified herein.

As used herein, the phrase “in communication,” including variations thereof, encompasses direct communication and/or indirect communication through one or more intermediary components, and does not require direct physical (e.g., wired) communication and/or constant communication, but rather additionally includes selective communication at periodic intervals, scheduled intervals, aperiodic intervals, and/or one-time events.

As used herein, “programmable circuitry” is defined to include (i) one or more special purpose electrical circuits (e.g., an application specific circuit (ASIC)) structured to perform specific operation(s) and including one or more semiconductor-based logic devices (e.g., electrical hardware implemented by one or more transistors), and/or (ii) one or more general purpose semiconductor-based electrical circuits programmable with instructions to perform specific functions(s) and/or operation(s) and including one or more semiconductor-based logic devices (e.g., electrical hardware implemented by one or more transistors). Examples of programmable circuitry include programmable microprocessors such as CPUs that may execute first instructions to perform one or more operations and/or functions, FPGAs that may be programmed with second instructions to cause configuration and/or structuring of the FPGAs to instantiate one or more operations and/or functions corresponding to the first instructions, GPUs that may execute first instructions to perform one or more operations and/or functions, DSPs that may execute first instructions to perform one or more operations and/or functions, XPUs, Network Processing Units (NPUs) one or more microcontrollers that may execute first instructions to perform one or more operations and/or functions and/or integrated circuits such as Application Specific Integrated Circuits (ASICs). For example, an XPU may be implemented by a heterogeneous computing system including multiple types of programmable circuitry (e.g., one or more FPGAs, one or more CPUs, one or more GPUs, one or more NPUs, one or more DSPs, etc., and/or any combination(s) thereof), and orchestration technology (e.g., application programming interface(s) (API(s)) that may assign computing task(s) to whichever one(s) of the multiple types of programmable circuitry is/are suited and available to perform the computing task(s).

As used herein integrated circuit/circuitry is defined as one or more semiconductor packages containing one or more circuit elements such as transistors, capacitors, inductors, resistors, current paths, diodes, etc. For example, an integrated circuit may be implemented as one or more of an ASIC, an FPGA, a chip, a microchip, programmable circuitry, a semiconductor substrate coupling multiple circuit elements, a system on chip (SoC), etc.

From the foregoing, it will be appreciated that example systems, apparatus, articles of manufacture, and methods have been disclosed that create composite reference structures for manufactured parts inspections by creating an un-bond condition in a particular area of a composite reference structure with an expected size of a film or foam adhesive bondline of laminates or bonded structure. Disclosed systems, apparatus, articles of manufacture, and methods improve the performance of using a computing device to perform manufactured parts inspection by providing a composite reference structure that more accurately represents a manufacturing defect for use during production parts testing. Disclosed systems, apparatus, articles of manufacture, and methods are accordingly directed to one or more improvement(s) in the operation of a machine such as a computer or other electronic and/or mechanical device.

The following paragraphs provide various examples of the examples disclosed herein.

Example 1 includes an apparatus comprising a first surface, a second surface opposing the first surface, a perimetric barrier along a perimeter of the second surface, the perimetric barrier protruding away from the second surface, an aperture formed through the first and second surfaces, and structural features formed on the second surface, the structural features extending between the aperture and the perimetric barrier.

Example 2 includes the apparatus of example 1, wherein the structural features are ridges.

Example 3 includes the apparatus of example 2, wherein a first one of the ridges abuts a second one of the ridges.

Example 4 includes the apparatus of example 1, wherein a shape of the perimetric barrier is at least one of a square or a rectangle.

Example 5 includes the apparatus of example 1, wherein a shape of the aperture is at least one of a square or a rectangle.

Example 6 includes the apparatus of example 1, further including a first protrusion on the perimetric barrier, the first protrusion extending from the perimetric barrier away from the second surface.

Example 7 includes the apparatus of example 6, further including a second protrusion extending from the perimetric barrier away from the second surface.

Example 8 includes an apparatus comprising a measurement reference structure having a first surface, a second surface opposing the first surface, and a perimetric barrier along a perimeter of the first and second surfaces, the perimetric barrier protruding away from the second surface, a first laminate engaging the first surface of the measurement reference structure, a second laminate engaging the perimetric barrier to create a seal along the perimeter, and an adhesive disposed between the first and second laminates, the adhesive abutting the perimetric barrier, the seal separating the adhesive from an air gap in the perimeter.

Example 9 includes the apparatus of example 8, further including an aperture formed through the first and second surfaces.

Example 10 includes the apparatus of example 8, wherein the measurement reference structure includes three-dimensional printable plastic.

Example 11 includes the apparatus of example 8, further including strength features formed on the second surface, a first one of the strength features abutting a second one of the strength features.

Example 12 includes the apparatus of example 11, wherein a strength of the strength features exceeds a fluid pressure created by the adhesive against the perimetric barrier.

Example 13 includes the apparatus of example 8, wherein a shape of the perimetric barrier is at least one of a square or a rectangle.

Example 14 includes the apparatus of example 8, further including first and second protrusions on the perimetric barrier, the first and second protrusions extending from the perimetric barrier away from the second surface, the first and second protrusions deforming the second laminate.

Example 15 includes the apparatus of example 8, wherein the measurement reference structure includes three-dimensional printable plastic, a melting-point of the three-dimensional printable plastic being higher than a melting-point of the first laminate.

Example 16 includes a measurement reference structure comprising a surface, a perimetric barrier along a perimeter of the surface, the perimetric barrier protruding from the surface, an aperture formed through the surface, and ridges formed on the surface, the ridges extending between the aperture and the perimetric barrier.

Example 17 includes the measurement reference structure of example 16, wherein a first one of the ridges abuts a second one of the ridges.

Example 18 includes the measurement reference structure of example 16, wherein a shape of the perimetric barrier is polygonal.

Example 19 includes the measurement reference structure of example 16, wherein a shape of the aperture is polygonal.

Example 20 includes the measurement reference structure of example 16, further including a first protrusion on the perimetric barrier, the first protrusion extending from the perimetric barrier away from the surface.

Example 21 includes a method comprising three-dimensional printing a support plate having an aperture therethrough, and three-dimensional printing a perimetric barrier along a perimeter of the support plate, the perimetric barrier protruding from the support plate.

Example 22 includes the method of example 21, wherein the three-dimensional printing of the support plate includes creating ridges on a surface of the support plate, the ridges extending between the aperture and the perimetric barrier.

Example 23 includes the method of example 21, wherein the three-dimensional printing of the support plate includes creating a first ridge on a surface of the support plate in abutment of a second ridge on the surface to create a lateral truss support system on the support plate.

Example 24 includes the method of example 21, further including three-dimensional printing a first protrusion on the perimetric barrier, the first protrusion extending from the perimetric barrier away from the support plate.

Example 25 includes the method of example 21, wherein the perimetric barrier and the aperture are polygonal shaped.

The following claims are hereby incorporated into this Detailed Description by this reference. Although certain example systems, apparatus, articles of manufacture, and methods have been disclosed herein, the scope of coverage of this patent is not limited thereto. On the contrary, this patent covers all systems, apparatus, articles of manufacture, and methods fairly falling within the scope of the claims of this patent.

1. An apparatus comprising:
a first surface;
a second surface opposing the first surface;
a perimetric barrier along a perimeter of the second surface, the perimetric barrier protruding away from the second surface;
an aperture formed through the first and second surfaces; and
structural features formed on the second surface, the structural features extending between the aperture and the perimetric barrier.

2. The apparatus of claim 1, wherein the structural features are ridges.

3. The apparatus of claim 2, wherein a first one of the ridges abuts a second one of the ridges.

4. The apparatus of claim 1, wherein a shape of the perimetric barrier is at least one of a square or a rectangle.

5. The apparatus of claim 1, wherein a shape of the aperture is at least one of a square or a rectangle.

6. The apparatus of claim 1, further including a first protrusion on the perimetric barrier, the first protrusion extending from the perimetric barrier away from the second surface.

7. The apparatus of claim 6, further including a second protrusion extending from the perimetric barrier away from the second surface.

8. An apparatus comprising:
a measurement reference structure having a first surface, a second surface opposing the first surface, and a perimetric barrier along a perimeter of the first and second surfaces, the perimetric barrier protruding away from the second surface;
a first laminate engaging the first surface of the measurement reference structure;
a second laminate engaging the perimetric barrier to create a seal along the perimeter; and
an adhesive disposed between the first and second laminates, the adhesive abutting the perimetric barrier, the seal separating the adhesive from an air gap in the perimeter.

9. The apparatus of claim 8, further including an aperture formed through the first and second surfaces.

10. The apparatus of claim 8, wherein the measurement reference structure includes three-dimensional printable plastic.

11. The apparatus of claim 8, further including strength features formed on the second surface, a first one of the strength features abutting a second one of the strength features.

12. The apparatus of claim 11, wherein a strength of the strength features exceeds a fluid pressure created by the adhesive against the perimetric barrier.

13. The apparatus of claim 8, wherein a shape of the perimetric barrier is at least one of a square or a rectangle.

14. The apparatus of claim 8, further including first and second protrusions on the perimetric barrier, the first and second protrusions extending from the perimetric barrier away from the second surface, the first and second protrusions deforming the second laminate.

15. The apparatus of claim 8, wherein the measurement reference structure includes three-dimensional printable plastic, a melting-point of the three-dimensional printable plastic being higher than a melting-point of the first laminate.

16. A measurement reference structure comprising:
a surface;
a perimetric barrier along a perimeter of the surface, the perimetric barrier protruding from the surface;
an aperture formed through the surface; and
ridges formed on the surface, the ridges extending between the aperture and the perimetric barrier.

17. The measurement reference structure of claim 16, wherein a first one of the ridges abuts a second one of the ridges.

18. The measurement reference structure of claim 16, wherein a shape of the perimetric barrier is polygonal.

19. The measurement reference structure of claim 16, wherein a shape of the aperture is polygonal.

20. The measurement reference structure of claim 16, further including a first protrusion on the perimetric barrier, the first protrusion extending from the perimetric barrier away from the surface.

21-25. (canceled)
